(19) United States
(12) Patent Application Publication
(10) Pub. No.: US 2017/0092206 A1
(43) Pub. Date: Mar. 30, 2017

(54) PRE-EMPHASIS CIRCUIT

(71) Applicant: Raydium Semiconductor Corporation, Hsinchu (TW)

(72) Inventors: Po-Cheng LIN, Hsinchu City (TW); Yu-Chung LIN, Jinhu Township (TW)

(21) Appl. No.: 15/218,994

(22) Filed: Jul. 25, 2016

(30) Foreign Application Priority Data
Sep. 30, 2015 (TW) 104132143

(51) Int. Cl. G09G 3/36

(52) U.S. Cl. CPC G09G 3/36; G09G 2310/0251; G09G 2310/0291; G09G 2320/0276

(57) ABSTRACT

A pre-emphasis circuit applied to a LCD panel is disclosed. The pre-emphasis circuit includes a digital-to-analog converting unit and a pre-emphasis control unit. The digital-to-analog converting unit includes a pre-emphasis switch. The digital-to-analog converting unit receives a data signal and a power reference level signal respectively and outputs an output signal. The pre-emphasis control unit is coupled to the digital-to-analog converting unit and used to selectively switch on or off the pre-emphasis switch to start or stop a pre-emphasis function performed on the output signal according to whether a grey-level code of the data signal is changed.

### BACKGROUND OF THE INVENTION

Field of the Invention

This invention relates to a liquid crystal display panel, especially to a pre-emphasis circuit applied to a liquid crystal display panel.

Description of the Related Art

With the development of the liquid crystal display technology, the display and electronic apparatus using the high-resolution and large-size liquid crystal display panels are popular and widely used in our daily life. However, because the resolution of the liquid crystal display panel are more and more higher and the size of the liquid crystal display panel are more and more larger, the load of the liquid crystal display panel will also become larger and the time for the driving IC to charge the liquid crystal display panel will become shorter. As shown in FIG. 1A, the driving IC of the conventional liquid crystal display panel will fail to provide enough charge amount to the liquid crystals at the distal end. Therefore, as shown in FIG. 1B, a pre-emphasis circuit is added to increase the charge amount that the driving IC provides to the liquid crystals at the distal end, so that the liquid crystal display panel can normally display frames.

However, as shown in FIG. 1B, in the pre-emphasis circuit of the driving IC of the conventional liquid crystal display panel, not only the switches SW1˜SW3 are disposed, but also capacitors C1 and C2 are disposed. In addition, in order to reduce the thermal noise and flicker noise, not only the capacitances of the capacitors C1 and C2 should be large enough, as shown in FIG. 1C, the timing diagram of switching on or switching off the switches SW1˜SW3 will become more complicated, and the control circuit of the driving IC will also become more complicated. As a result, the costs of the driving IC of the conventional liquid crystal display panel will be also increased and its market competitiveness will become poor.

### SUMMARY OF THE INVENTION

Therefore, the invention provides a pre-emphasis circuit applied to a liquid crystal display panel to solve the above-mentioned problems.

An embodiment of the invention is a pre-emphasis circuit. In this embodiment, the pre-emphasis circuit is applied to a liquid crystal display panel. The pre-emphasis circuit includes a digital-to-analog converting unit and a pre-emphasis control unit. The digital-to-analog converting unit includes a pre-emphasis switch. The digital-to-analog converting unit receives a data signal and a power reference level signal respectively and outputs an output signal. The pre-emphasis control unit is coupled to the digital-to-analog converting unit and used to selectively switch on or switch off the pre-emphasis switch to start or stop a pre-emphasis function performed on the output signal according to whether a grey-level code of the data signal is changed.

In an embodiment, the pre-emphasis control unit determines that the grey-level code of the data signal is not changed, the pre-emphasis control unit switches on the pre-emphasis switch to stop the pre-emphasis function.

In an embodiment, when the pre-emphasis control unit determines that the grey-level code of the data signal is changed, the pre-emphasis control unit switches off the pre-emphasis switch to start the pre-emphasis function.

In an embodiment, when the pre-emphasis control unit determines that the grey-level code of the data signal is changed from a first grey-level code to a second grey-level code, the pre-emphasis control unit further compares the first grey-level code with the second grey-level code.

In an embodiment, the pre-emphasis control unit divides all grey-level codes into N levels of grey-level code from low-level to high-level respectively, the N levels of grey-level code comprises a first level of grey-level code, a second level of grey-level code, . . . , a N-th level of grey-level code corresponding to a first switch, a second switch, . . . , a N-th switch respectively, and the second grey-level code belongs to a K-th level of grey-level code of the N levels of grey-level code, N and K are positive integers.

In an embodiment, if a comparing result of the pre-emphasis control unit is that the first grey-level code is lower than the second grey-level code, the grey-level code of the data signal is changed from low-level to high-level, and the pre-emphasis control unit switches on a K-th switch corresponding to the K-th level of grey-level code to start the pre-emphasis function.

In an embodiment, the pre-emphasis function is to pre-charge the output signal during a pre-emphasis period that the K-th switch is switched on.

In an embodiment, if a comparing result of the pre-emphasis control unit is that the first grey-level code is higher than the second grey-level code, the grey-level code of the data signal is changed from high-level to low-level, and the pre-emphasis control unit switches on a (K−1)-th switch corresponding to a (K−1)-th level of grey-level code to start the pre-emphasis function; the (K−1)-th level of grey-level code is one level lower than the K-th level of grey-level code.

In an embodiment, the pre-emphasis function is to pre-discharge the output signal during a pre-emphasis period that the (K−1)-th switch is switched on.

In an embodiment, the power reference level signal comprises a first power reference level and a second power reference level, and the first power reference level is lower than the second power reference level; the first power reference level corresponds to a zeroth pre-emphasis switch when K=1 and the second power reference level corresponds to the N-th switch.

In an embodiment, the first power reference level and the second power reference level are a half analog operating voltage and an analog operating voltage respectively.

Compared to the prior art, when the load of the liquid crystal display panel is large or the time charging the liquid crystal display panel is short, the pre-emphasis circuit applied to the liquid crystal display panel of the invention can effectively enhance the driving capability of the driving IC to provide enough charge amount to the liquid crystal display panel; therefore, the liquid crystal display panel can normally display frames without abnormal conditions. In addition, no large-capacity capacitor is necessary for the pre-emphasis circuit applied to the liquid crystal display panel of the invention, so that the circuit complexity and costs of the driving IC can be effectively reduced to increase its market competitiveness.

The advantage and spirit of the invention may be understood by the following detailed descriptions together with the appended drawings.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1A illustrates a schematic diagram of the driving IC of the conventional LCD panel providing insufficient charge amount to the liquid crystals at the distal end.

FIG. 1B illustrates a schematic diagram of adding a pre-emphasis circuit to increase the charge amount that the driving IC provides to the liquid crystals at the distal end.

FIG. 1C illustrates a timing diagram of the switching signals of the pre-emphasis circuit shown in FIG. 1B.

FIG. 2 illustrates a schematic diagram of the pre-emphasis circuit applied to the LCD panel in an embodiment of the invention.

FIG. 3A and FIG. 3B illustrate schematic diagrams before and after the pre-emphasis circuit performs the pre-emphasis function on the output signal.

FIG. 4 illustrates a schematic diagram of dividing all grey-level codes into N levels of grey-level code from low-level to high-level respectively.

FIG. 5 illustrates a schematic diagram that the pre-emphasis switch in the digital-to-analog converting unit should be switched off when the pre-emphasis function is started.

FIG. 6A˜FIG. 6D illustrate timing diagrams of the pre-emphasis circuit performing the pre-emphasis function under different conditions.

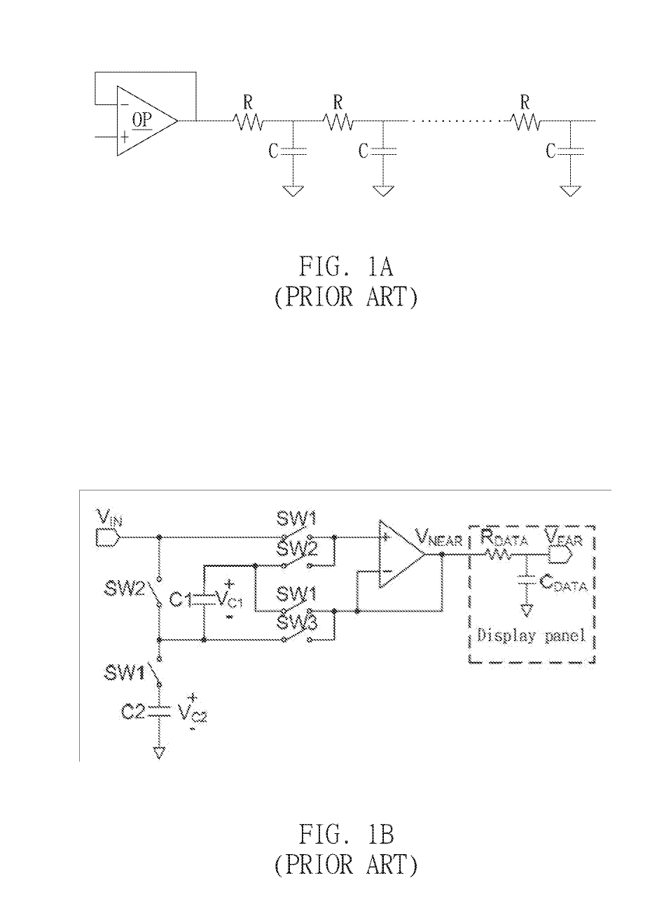

### DETAILED DESCRIPTION

A preferred embodiment of the invention is a pre-emphasis circuit. In this embodiment, the pre-emphasis circuit is applied to a liquid crystal display panel. When the load of the liquid crystal display panel becomes larger or the time for the driving IC to charge the liquid crystal display panel becomes shorter, the pre-emphasis circuit of the invention can enhance the driving capability of its source driver to the liquid crystals at the distal end and shorten the time charging to a target voltage, so that the liquid crystal display panel can normally display frames, but not limited to this.

In general, the main function of the source driver of the liquid crystal display panel is to convert a serial digital signal provided by the system board into a parallel signal, and then the parallel signal is converted into an analog voltage by a digital-to-analog converting circuit and the analog voltage is outputted to data lines of the liquid crystal display panel to control the operation of liquid crystals.

It should be noted that the invention provides new circuit designs to the digital-to-analog converting circuit of the pre-emphasis circuit to provide the pre-emphasis function without increasing the circuit complexity and costs of the source driver, so that the problems of high load and short charging time occurred in the conventional liquid crystal display panel can be solved.

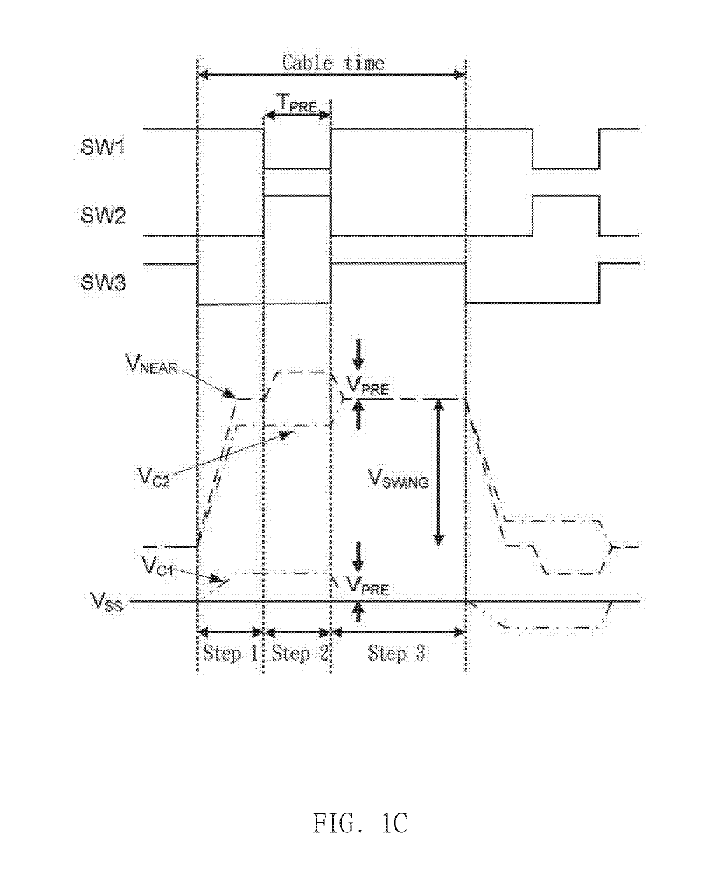

Please refer to FIG. 2. FIG. 2 illustrates a schematic diagram of the pre-emphasis circuit applied to the LCD panel in this embodiment. As shown in FIG. 2, the pre-emphasis circuit 2 is coupled between the Gamma correction unit 3 and the output buffer 4. The output terminal of the output buffer 4 is coupled to the data line DL of the liquid crystal display panel 5. The N pixels P1˜PN on the data line DL include RC loadings formed by the resistor R1 and the capacitor C1, the resistor R2 and the capacitor C2, . . . , and the resistor RN and the capacitor CN respectively. In practical applications, in order to rapidly discharge the data line DL and the N pixels P1˜PN to the target voltage level, the output buffer 4 can be a unit-gain operational amplifier, but not limited to this.

In this embodiment, the pre-emphasis circuit 2 includes a digital-to-analog converting unit 20 and a pre-emphasis control unit 22. The digital-to-analog converting unit 20 includes a pre-emphasis switch 200 and a digital-to-analog converter 202. The digital-to-analog converting unit 20 is coupled to the Gamma correction unit 3, the pre-emphasis control unit 22 and the positive input terminal + of the output buffer 4 respectively and the digital-to-analog converting unit 20 receives a power reference level signal PREF. The pre-emphasis switch 200 is coupled to the digital-to-analog converter 202.

The digital-to-analog converting unit 20 receives the digital data signal DD and the power reference level signal PREF respectively and outputs the output signal VOUT which is analog voltage type. The pre-emphasis control unit 22 uses the pre-emphasis control signal to selectively switch on or switch off the pre-emphasis switch 200 to start or stop a pre-emphasis function performed on the output signal VOUT according to whether a grey-level code of the data signal DD is changed.

In an embodiment, when the pre-emphasis control unit 22 determines that the grey-level code of the data signal DD is not changed, the pre-emphasis control unit 22 will switch on the pre-emphasis switch 200 to stop the pre-emphasis function. Therefore, at this time, the pre-emphasis function is not performed on the output signal VOUT. In other words, at this time, the output signal VOUT will not be pre-charged or pre-discharged.

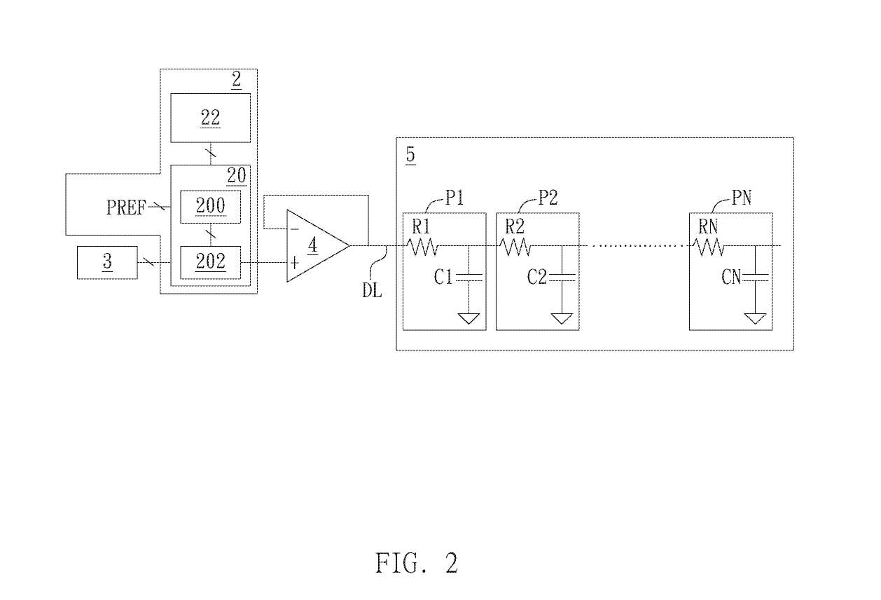

In another embodiment, when the pre-emphasis control unit 22 determines that the grey-level code of the data signal DD is changed, the pre-emphasis control unit 22 will switch off the pre-emphasis switch 200 to start the pre-emphasis function. Therefore, at this time, the pre-emphasis function is performed on the output signal VOUT. In other words, at this time, the output signal VOUT will be pre-charged or pre-discharged. FIG. 3A and FIG. 3B illustrate schematic diagrams before and after the pre-emphasis circuit 2 performs the pre-emphasis function on the output signal VOUT.

When the pre-emphasis control unit 22 determines that the grey-level code of the data signal DD is changed, that is to say, the grey-level code of the data signal DD is changed from a first grey-level code to a second grey-level code, the pre-emphasis control unit 22 has to further compare the first grey-level code with the second grey-level code, so that the pre-emphasis control unit 22 can determine the grey-level code of the data signal DD is changed from low-level to high-level or from high-level to low-level.

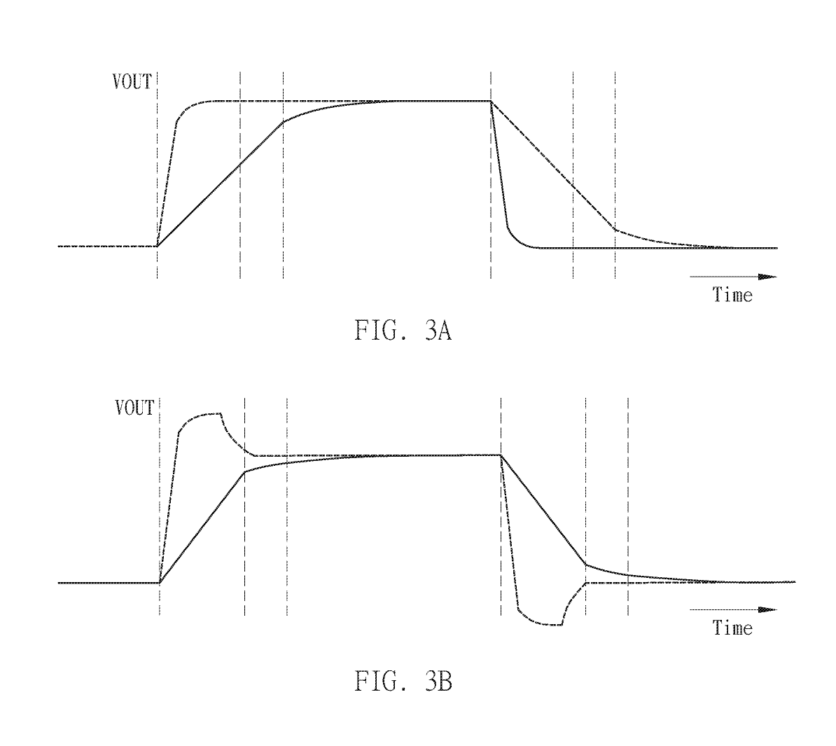

Then, please refer to FIG. 4. FIG. 4 illustrates a schematic diagram of dividing all grey-level codes into N levels of grey-level code from low-level to high-level respectively.

As shown in FIG. 4, in an embodiment, it is assumed that the pre-emphasis control unit 22 divides all grey-level codes into N levels of grey-level code G1˜GN from low-level to high-level respectively. The N levels of grey-level code G1˜GN include a first level of grey-level code G1, a second level of grey-level code G2, . . . , a N-th level of grey-level code GN corresponding to a first switch SW1, a second switch SW2, . . . , a N-th switch SWN respectively. Each of the first level of grey-level code G1, the second level of grey-level code G2, . . . , the N-th level of grey-level code GN includes a plurality of grey-level codes.

In addition, the grey-level code of the data signal DD is changed from the first grey-level code to the second grey-level code, and the second grey-level code belongs to a K-th level of grey-level code GK of the N levels of grey-level code G1˜GN, wherein N and K are positive integers. Next, two possible comparing results of the pre-emphasis control unit 22 comparing the first grey-level code with the second grey-level code will be introduced as follows.

(1) The first possible comparing result: if the comparing result of the pre-emphasis control unit 22 is that the first grey-level code is lower than the second grey-level code, that is to say, the first grey-level code is lower than the K-th level of grey-level code GK; it means that the grey-level code of the data signal DD is changed from low-level to high-level. At this time, the pre-emphasis control unit 22 will switch on a K-th switch SWK corresponding to the K-th level of grey-level code GK to start the pre-emphasis function. And, the pre-emphasis function is to pre-charge the output signal VOUT during a pre-emphasis period that the K-th switch SWK is switched on, but not limited to this.

(2) The second possible comparing result: if the comparing result of the pre-emphasis control unit 22 is that the first grey-level code is higher than the second grey-level code, that is to say, the first grey-level code is higher than the K-th level of grey-level code GK; it means that the grey-level code of the data signal DD is changed from high-level to low-level. At this time, the pre-emphasis control unit 22 will switch on a (K−1)-th switch SW(K−1) corresponding to the (K−1)-th level of grey-level code G(K−1) to start the pre-emphasis function. And, the pre-emphasis function is to pre-discharge the output signal VOUT during a pre-emphasis period that the (K−1)-th switch SW(K−1) is switched on, but not limited to this. The (K−1)-th level of grey-level code G(K−1) is one level lower than the K-th level of grey-level code GK.

It should be noticed that in order to effectively perform pre-emphasis function on the highest grey-level code and the lowest grey-level code, the power reference level signal PREF of this embodiment includes a first power reference level VREF1 and a second power reference level VREF2, and the first power reference level VREF1 is lower than the second power reference level VREF2. The first power reference level VREF1 corresponds to a zeroth pre-emphasis switch SW0 when K=1 and the second power reference level VREF2 corresponds to the N-th switch SWN.

In practical applications, the first power reference level VREF1 and the second power reference level VREF2 of the power reference level signal PREF are a half analog operating voltage (HAVDD) and an analog operating voltage (AVDD) respectively, but not limited to this.

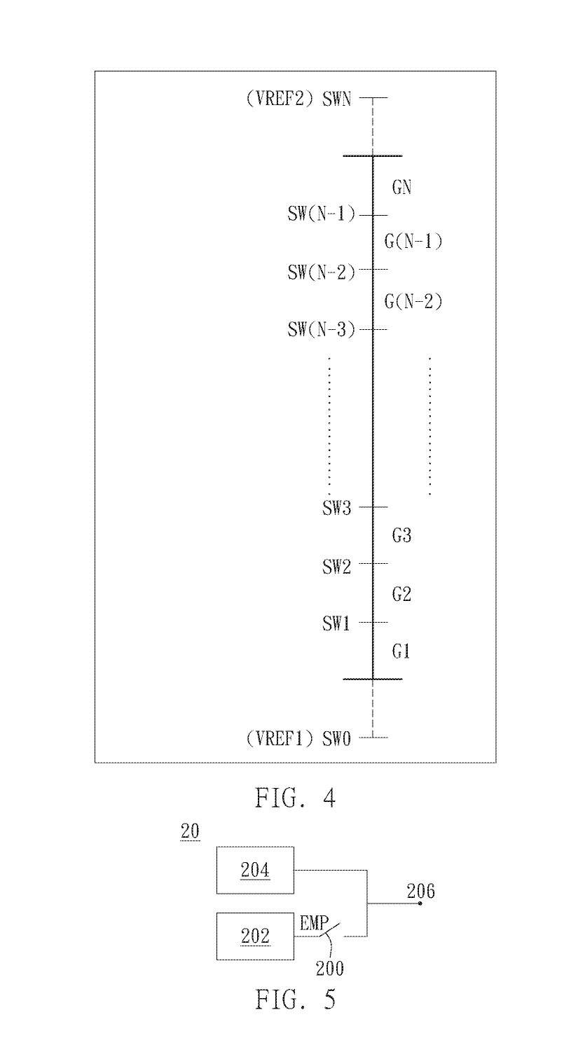

Please refer to FIG. 5. FIG. 5 illustrates a schematic diagram that the pre-emphasis switch in the digital-to-analog converting unit should be switched off when the pre-emphasis function is started. As shown in FIG. 5, the digital-to-analog converting unit 20 includes a pre-emphasis switch 200, a digital-to-analog converter 202, an auxiliary digital-to-analog converter 204 and an output terminal 206. The digital-to-analog converter 202 and the auxiliary digital-to-analog converter 204 are coupled to the output terminal 206 respectively, and the pre-emphasis switch 200 is disposed between the digital-to-analog converter 202 and the output terminal 206.

When the pre-emphasis control unit 22 determines that the grey-level code of the data signal DD is changed, the pre-emphasis control unit 22 will selectively switch on the K-th switch SWK or the (K−1)-th switch SW(K−1) to start the pre-emphasis function according to whether the grey-level code of the data signal DD is changed from low-level to high-level or from high-level to low-level. At the same time, the pre-emphasis control unit 22 should switch off the pre-emphasis switch 200 disposed between the digital-to-analog converter 202 and the output terminal 206 to cut the electrical connection between the digital-to-analog converter 202 and the output terminal 206. Therefore, the output signal of the digital-to-analog converter 202 will be not outputted by the output terminal 206, the pre-charging or pre-discharging performed on the output signal VOUT can be finished during the pre-emphasis period.

When the pre-charging or pre-discharging is finished, the pre-emphasis control unit 22 will switch off the K-th switch SWK or the (K−1)-th switch SW(K−1) to stop the pre-emphasis function. At the same time, the pre-emphasis control unit 22 should switch o0 the pre-emphasis switch 200 disposed between the digital-to-analog converter 202 and the output terminal 206 to electrically connect the digital-to-analog converter 202 with the output terminal 206. Therefore, the output signal of the digital-to-analog converter 202 will be outputted by the output terminal 206.

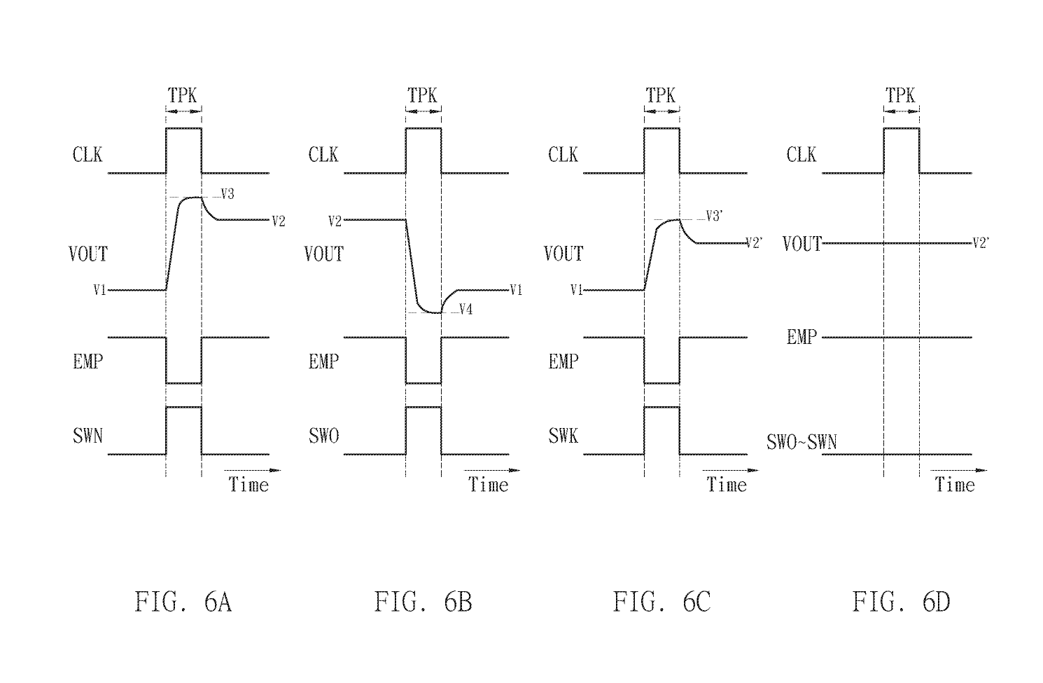

Please refer to FIG. 6A˜FIG. 6D. FIG. 6A˜FIG. 6D illustrate timing diagrams of the pre-emphasis circuit performing the pre-emphasis function under different conditions respectively.

As shown in FIG. 6A, when the pre-emphasis control unit 22 switches the N-th switch SWN, the pre-emphasis switch 200 will be switched off by a pre-emphasis switch control signal EMP, the output signal VOUT will be pre-charged during the pre-emphasis period TPK that the N-th switch SWN is switched on, so that the voltage level of the output signal VOUT will be increased from V1 to V3.

As shown in FIG. 6B, when the pre-emphasis control unit 22 switches the zeroth switch SW0, the pre-emphasis switch 200 will be switched off by a pre-emphasis switch control signal EMP, the output signal VOUT will be pre-discharged during the pre-emphasis period TPK that the zeroth switch SW0 is switched on, so that the voltage level of the output signal VOUT will be decreased from V2 to V4.

As shown in FIG. 6C, when the pre-emphasis control unit 22 switches the K-th switch SWK, the pre-emphasis switch 200 will be switched off by a pre-emphasis switch control signal EMP, the output signal VOUT will be pre-charged during the pre-emphasis period TPK that the K-th switch SWK is switched on, so that the voltage level of the output signal VOUT will be increased from V1 to V3′.

As shown in FIG. 6D, when the pre-emphasis control unit 22 determines that the grey-level code of the data signal DD is not changed, the pre-emphasis control unit 22 will not switch on any of the zeroth switch SW0˜the N-th switch SWN. At this time, the pre-emphasis function is not started and the voltage level of the output signal VOUT is maintained at V2′ without being pre-charged or pre-discharged. And, the pre-emphasis switch 200 will be also switched on instead of being switched off by the pre-emphasis switch control signal EMP.

Compared to the prior art, when the load of the liquid crystal display panel is large or the time charging the liquid crystal display panel is short, the pre-emphasis circuit applied to the liquid crystal display panel of the invention can effectively enhance the driving capability of the driving IC to provide enough power to the liquid crystal display panel; therefore, the liquid crystal display panel can normally display frames without abnormal conditions. In addition, no large-capacity capacitor is necessary for the pre-emphasis circuit applied to the liquid crystal display panel of the invention, so that the circuit complexity and costs of the driving IC can be effectively reduced to increase its market competitiveness.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

1. A pre-emphasis circuit applied to a LCD panel, the pre-emphasis circuit comprising:
a digital-to-analog converting unit comprising a pre-emphasis switch, the digital-to-analog converting unit receiving a data signal and a power reference level signal respectively and outputting an output signal; and
a pre-emphasis control unit coupled to the digital-to-analog converting unit, the pre-emphasis control unit selectively switching on or switching off the pre-emphasis switch to stop or start a pre-emphasis function performed on the output signal according to whether a grey-level code of the data signal is changed.

2. The pre-emphasis circuit of claim 1, wherein when the pre-emphasis control unit determines that the grey-level code of the data signal is not changed, the pre-emphasis control unit switches on the pre-emphasis switch to stop the pre-emphasis function.

3. The pre-emphasis circuit of claim 1, wherein when the pre-emphasis control unit determines that the grey-level code of the data signal is changed, the pre-emphasis control unit switches off the pre-emphasis switch to start the pre-emphasis function.

4. The pre-emphasis circuit of claim 3, wherein when the pre-emphasis control unit determines that the grey-level code of the data signal is changed from a first grey-level code to a second grey-level code, the pre-emphasis control unit further compares the first grey-level code with the second grey-level code.

5. The pre-emphasis circuit of claim 4, wherein the pre-emphasis control unit divides all grey-level codes into N levels of grey-level code from low-level to high-level respectively, the N levels of grey-level code comprises a first level of grey-level code, a second level of grey-level code, . . . , a N-th level of grey-level code corresponding to a first switch, a second switch, . . . , a N-th switch respectively, and the second grey-level code belongs to a K-th level of grey-level code of the N levels of grey-level code, N and K are positive integers.

6. The pre-emphasis circuit of claim 5, wherein if a comparing result of the pre-emphasis control unit is that the first grey-level code is lower than the second grey-level code, the grey-level code of the data signal is changed from low-level to high-level, and the pre-emphasis control unit switches on a K-th switch corresponding to the K-th level of grey-level code to start the pre-emphasis function.

7. The pre-emphasis circuit of claim 6, wherein the pre-emphasis function is to pre-charge the output signal during a pre-emphasis period that the K-th switch is switched on.

8. The pre-emphasis circuit of claim 5, wherein if a comparing result of the pre-emphasis control unit is that the first grey-level code is higher than the second grey-level code, the grey-level code of the data signal is changed from high-level to low-level, and the pre-emphasis control unit switches on a (K−1)-th switch corresponding to a (K−1)-th level of grey-level code to start the pre-emphasis function; the (K−1)-th level of grey-level code is one level lower than the K-th level of grey-level code.

9. The pre-emphasis circuit of claim 8, wherein the pre-emphasis function is to pre-discharge the output signal during a pre-emphasis period that the (K−1)-th switch is switched on.

10. The pre-emphasis circuit of claim 8, wherein the power reference level signal comprises a first power reference level and a second power reference level, and the first power reference level is lower than the second power reference level; the first power reference level corresponds to a zeroth pre-emphasis switch when K=1 and the second power reference level corresponds to the N-th switch.

11. The pre-emphasis circuit of claim 10, wherein the first power reference level and the second power reference level are a half analog operating voltage and an analog operating voltage respectively.
